(19) United States
(12) Patent Application Publication
(10) Pub. No.: US 2014/0004774 A1
(43) Pub. Date: Jan. 2, 2014

(54) Support Assembly For Use With A Machine Tool And Methods Of Operation Thereof

(71) Applicant: Dermot Robert Falkner, Yorkshire (GB)

(72) Inventor: Dermot Robert Falkner, Yorkshire (GB)

(73) Assignee: Cinetic Landis Limited, Yorkshire (GB)

(21) Appl. No.: 14/005,287

(22) PCT Filed: Apr. 3, 2012
(86) PCT No.: PCT/GB2012/050749

§ 371 Date: Sep. 16, 2013

(30) Foreign Application Priority Data
Apr. 8, 2011 (GB) 1106012.6

(51) Int. Cl. B24B 49/04; F16M 13/02; B24B 5/42

(52) U.S. Cl. CPC B24B 49/04; B24B 5/42; F16M 13/022
USPC 451/49; 451/442; 451/28; 248/286.1

(57) ABSTRACT

An assembly for carrying a measuring gauge to be maintained in contact with a portion of a workpiece mounted in a machine tool arranged to rotate the workpiece about a machine reference axis. The assembly is for mounting on a carriage shared with a material removing tool and comprises a slide which is slidable in the direction of infeed of said material removing tool. A mount coupling is pivotally coupled to the slide by a pivot and is arranged to accommodate variation of the spacing between the mount and the pivot due to the rotary motion of said workpiece portion. A slide driver is arranged to reciprocate the slide relative to the slide support in synchronism with the rotation of said workpiece portion. An associated method is also provided.

### FIELD OF THE INVENTION

The present invention relates to a support assembly for use with a machine tool. More particularly, it concerns a mechanism for carrying a measuring gauge to be maintained in contact with a workpiece mounted in a machine tool.

### BACKGROUND TO THE INVENTION

There are various known mechanisms for maintaining a measuring gauge in contact with a workpiece. More specifically, mechanisms have been developed to support a gauge which measures the diameter and roundness of a cylindrical workpiece rotating about a central reference axis, or a cylindrical portion orbiting around a central is reference axis of a workpiece as the workpiece is rotated in a machine tool.

U.S. Pat. No. 4,637,144 discloses an apparatus for monitoring the diameters of round objects rotating in a machine tool. The apparatus is supported by a holder which may be mounted on a carriage which reciprocates along ways provided in or on the table of the machine tool. Alternatively, the holder may be removably secured to the frame of the machine tool.

WO-97/12724 describes an apparatus for checking the diameter of crankpins of a crankshaft in the course of the machining of the crankshaft in a grinding machine. A first arm rotates with respect to a support arranged on the grinding wheel slide of the grinding machine. A second arm rotates with respect to the first and carries a measuring device.

FIG. 1 shows a machine tool including two known measuring gauge positioning arms 102, 102a. Two grinding wheels 101 and 101a are mounted on the machine for engagement with a workpiece. Grinding wheel 101 and positioning arm 102 are mounted on the same carriage assembly 103. Each positioning arm 102, 102a is in the form of a complex arrangement of hydraulically actuated linkages. It includes hydraulic actuation and a combination of springs and self-weight to ensure that respective measuring vees 104, 104a remain in intimate contact with the workpiece.

### SUMMARY OF THE INVENTION

The present invention provides an assembly for carrying a measuring gauge to be maintained in contact with a portion of a workpiece mounted in a machine tool arranged to rotate the workpiece about a machine reference axis, wherein the assembly comprises:

a slide support;

a slide which is slidably mounted on the slide support;

a mount for connection to said measuring gauge;

a mount coupling which couples the mount to the slide, is pivotally coupled to the slide and is arranged to allow variation of the spacing between the mount and the slide; and

a slide driver for reciprocating the slide relative to the slide support in synchronism with the rotary motion of said workpiece portion.

The combination of features provided in accordance with the invention forms a mechanism able to maintain a measuring gauge in contact with a rotating workpiece portion with fewer degrees of freedom relative to known arrangements. Accordingly, the location of the measuring gauge can be more accurately monitored, and the mechanism is less complex to construct and install on a machine tool. In practice, only one adjustment may be required during installation of the assembly on a machine, namely the angle between the mount coupling and slide. This is in marked contrast to some known arrangements which require multiple adjustments in order to set up a positioning arm ready for use on a particular machine.

The assembly is particularly suitable for maintaining a gauge in contact with a workpiece portion which follows an orbital path around the machine reference axis as the workpiece rotates. The slide driver may be controlled to reciprocate the slide relative to the slide support in synchronism with the orbital motion of the workpiece portion.

The slide and slide driver of the present assembly enable adjustment of the mount coupling location relative to the slide support. When the assembly is mounted on a common carriage with a material removing tool of a machine tool, this slide arrangement facilitates control of the location of the mount coupling relative to the material removing tool. The inventor realised that this degree of freedom in combination with a pivotably mounted mount coupling facilitates maintenance of a measuring gauge in contact with a workpiece portion following an orbital path. This may be achieved without risk of the measuring gauge coming into contact with the material removing tool by angling the mount coupling back from the slide towards the workpiece and the material removing tool.

The slide driver may be controlled to reciprocate the slide relative to the slide support substantially in synchronism with the motion of a workpiece portion. In this way, the assembly is enabled to accommodate changes in the location of the portion of the workpiece relative to the slide support so as to maintain the measuring gauge in engagement with the workpiece portion. Preferably, the following error between the slide support and workpiece portion is sub-millimetre.

The trajectory of an orbiting part, relative to a reciprocating wheel-feed axis, can be resolved into a short horizontal motion and a longer vertical motion. The frequency of the horizontal motion is simple harmonic and twice the reciprocating frequency of the wheel-feed axis. The vertical motion is simple harmonic at the wheel-feed frequency. The distances from a nominal start position of both vertical and horizontal displacements are readily calculated by trigonometry.

In a preferred embodiment, the slide is slidable linearly with respect to the slide support, along a linear axis of motion. Where the assembly is mounted on a common carriage with a material removing tool, the axis of motion of the slide may be arranged parallel to the direction of infeed of the material removing tool. Thus, the assembly (and in particular, the slide) is able to move relative to the common carriage to adjust a small fraction of the wheel-feed distance (measured relative to the machine reference axis) to keep a measuring gauge in contact with an orbiting workpiece portion.

The mount coupling is coupled to the slide by a pivot so as to be rotatable relative to the slide about the pivot. Preferably, the mount coupling is arranged to facilitate variation of the spacing between the mount and the slide and, more preferably, between the mount and the pivot. The spacing may be variable along a linear reference axis.

The mount coupling may accommodate motion of the mount which is in a lateral direction with respect to the direction of reciprocation of the slide (and preferably of the material removing tool).

In a preferred embodiment, the linear reference axis passes through the pivot and the mount coupling varies the spacing between the mount and the pivot along the linear reference axis. The mount coupling may be able to vary its length along the linear reference axis to accommodate changes in the spacing between the mount and the pivot due to the orbital motion of the workpiece portion. For example, the mount coupling may comprise a telescopic device.

Reciprocation of the slide and the change in length of the mount coupling may be the only degrees of freedom used by the assembly to follow a point exhibiting orbital motion.

In preferred embodiments, the assembly includes a retractor for retracting the mount away from the machine reference axis. The distal end of the assembly may thereby be drawn away from the working area of the machine when not in use. More particularly, the retractor may be arranged to pivot the mount coupling upwards. The retractor may comprise a piston, and a piston rod coupling the piston to the mount coupling such that actuation of the piston causes the linear reference axis of the mount coupling to pivot relative to the slide.

The assembly may be controlled by a dedicated controller. In embodiments, it may be arranged to be responsive to control signals originating from the controller of an associated machine tool. Those signals may be received directly from the machine tool controller or via the assembly's dedicated controller. This facilitates precise coordination of movement of the assembly with other movements controlled by the machine tool controller. A workpiece may be simultaneously measured using a measuring gauge mounted on the assembly whilst being machined by the machine tool.

The present invention further provides a method for maintaining a measuring gauge in engagement with a portion of a workpiece rotating in a machine tool about a machine reference axis, the method comprising the steps of:

providing an assembly carrying the measuring gauge, the assembly including a slide which is slidably mounted on a slide support, a mount connected to the measuring gauge, and a mount coupling which couples the mount to the slide, is pivotally coupled to the slide and is arranged to facilitate variation of the spacing between the mount and the slide;

arranging the assembly such that the measuring gauge is in engagement with the portion of the workpiece; and

rotating the workpiece about the machine reference axis, with the assembly accommodating changes in the location of the measuring gauge relative to the slide support so as to maintain the measuring gauge in engagement with the portion of the workpiece.

The measuring gauge may follow a surface centred on the machine reference axis. In a preferred method, the portion of the workpiece follows an orbital path around the machine reference axis as the workpiece rotates, and the method includes a step of reciprocating the slide relative to the slide support in synchronism with the orbital motion of said workpiece portion about the machine reference axis. For example, the workpiece may be a crankshaft and the workpiece portion in the form of a crank pin.

The measuring gauge may therefore be positioned in synchronism with the rotation of the workpiece about the machine reference axis such that the gauge remains in intimate contact with the surface of the rotating workpiece.

### BRIEF DESCRIPTION OF THE DRAWINGS

Embodiments of the invention will now be described by way of example and with reference to the accompanying schematic drawings, wherein:

FIG. 1 is a perspective view of a known machine tool including known gauge positioning arms;

FIG. 2 is a side view of an assembly embodying the present invention together with a grinding wheel and workpiece;

FIGS. 3 and 4 show a retractor for inclusion in the assembly of FIG. 2; and

FIGS. 5 to 11 show successive stages in the orbital motion of a workpiece whilst it is maintained in contact with a grinding wheel and a measuring gauge supported by an assembly embodying the present invention.

### DETAILED DESCRIPTION OF THE DRAWINGS

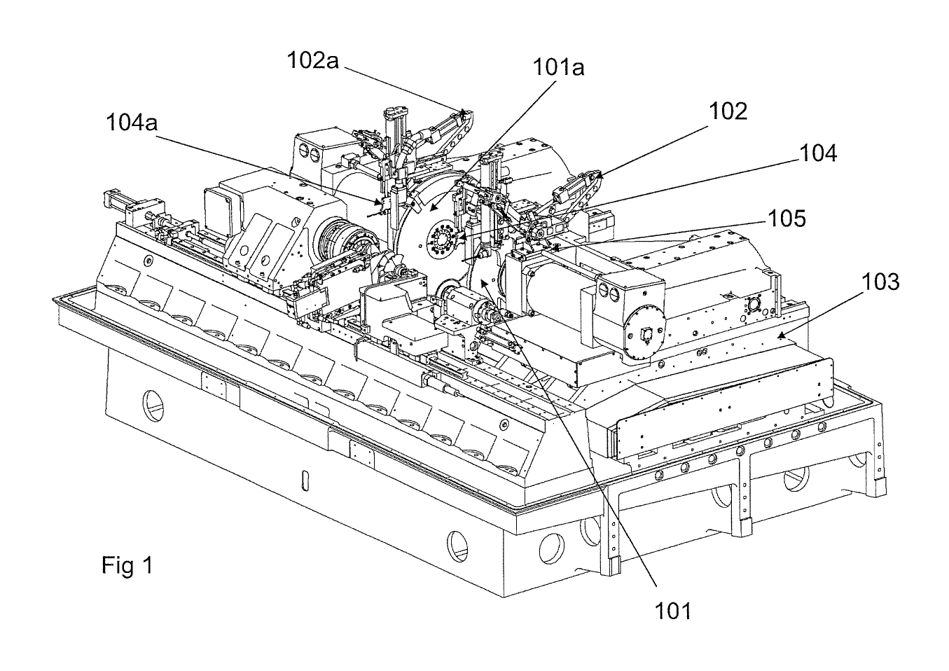

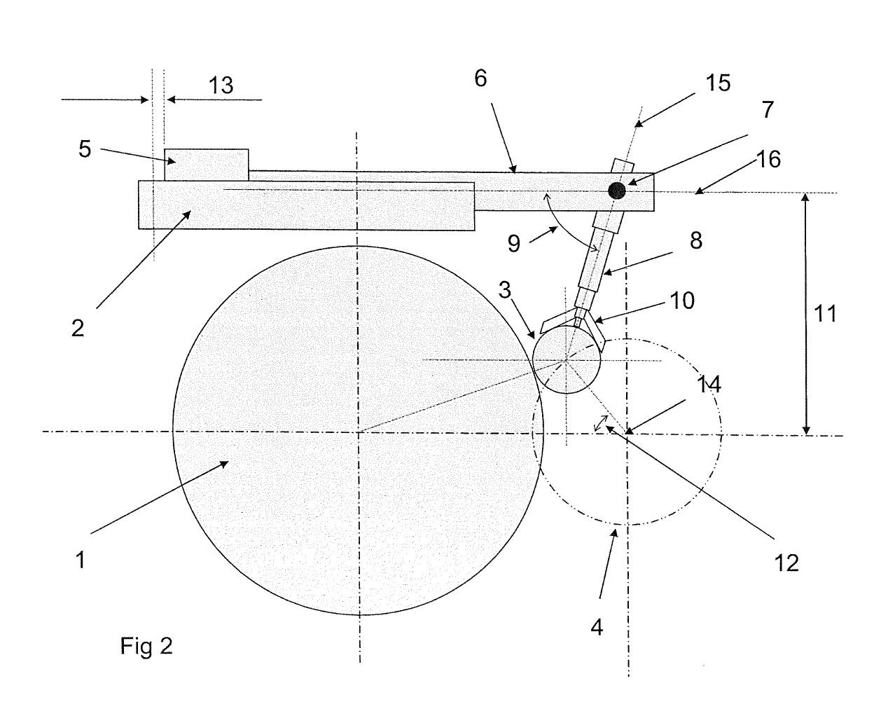

An assembly embodying the present invention is depicted schematically in FIG. 2. A slide support 2 is provided for mounting onto a supporting structure. For example, this may be a wheel spindle's wheel side bearing block 105 as shown in FIG. 1. A slide 6 is constrained to move linearly by bearing rails fixed to the slide support 2.

A mount coupling in the form of a telescoping rod 8 is attached to the slide at a pivot point 7.

A slide driver in the form of a drive motor 5 is provided to displace the slide 6 with respect to the slide support 2.

A gauge head 10 is mounted on the distal end of the rod 8. During a machining operation, grinding wheel 1 is maintained in contact with a workpiece portion 3 as it follows an orbital path 4 about a machine reference axis 14. The assembly maintains gauge head 10 in contact with the surface of the workpiece portion.

The reference axis 15 of the telescoping rod 8 and reference axis 16 of the slide intersect at the pivot 7. The angle 9 defined between the axes 15 and 16 at the pivot is selected to ensure that the gauge head 10 is not damaged in use by the grinding wheel 1 as it follows the normal excursions of its point of contact with the workpiece 3. The pivoting action of the coupling 8 about pivot 7 is constrained to a few degrees either side of its nominal selected angle. The constraint may be provided by a passive spring-actuated centralising mechanism for example (not shown). This constrained degree of rotation is provided to overcome any inaccuracies in the setup of the assembly and any deviations from a perfect workpiece following motion provided by the slider driver 5.

The length range of the telescoping rod 8 is determined by the height 11 of the pivot 7 above the machine reference axis 14, the radius of the workpiece portion 3, the nominal angle 9, and the throw of the orbit of a workpiece portion about reference axis 14, and varies in proportion to the arcsin of the angle 12 of the rotation of the workpiece.

Slide driver 5 may be implemented in the form of a linear motor and linear encoder. Alternatively, it may be formed by a rotary encoder and motor combination driving the slide via a lead-screw. The displacement 13 of the slide 6 relative to slide support 2 is proportional to the square of the arcsin of the angle 12 of the rotation of the workpiece.

The telescoping arm 8 may be provided with one or a combination of pre-load devices to ensure that the gauge vee runs in continuous intimate contact with the surface of the rotating workpiece. The pre-loaded device(s) may be selected from a resilient mechanical mechanism, a pneumatic mechanism, and a hydraulic mechanism.

Pivot point 7 is located above and ahead of the grinding wheel 1 at all times by movement of slide 6 such that angle 9 between the mount coupling and slide is always an acute angle. The gauge head thereby bears on the workpiece without coming into contact with the grinding wheel. Preferably, the acute angle is kept substantially the same throughout the motion of the workpiece. This angle may be about 73° as shown in the drawings, for example. However the most appropriate angle may vary depending on the particular support assembly and machine configuration concerned.

As shown, the assembly may be implemented with only a single pivotal coupling between the support of the assembly and the mount for the measuring gauge. The mount coupling is pivotable about an axis through point 7 which is parallel to the machine reference axis 14.

The slide driver is preferably controlled by the same control system as the machine tool, to facilitate co-ordination of its motion with that of the grinding wheel and the rotation of the workpiece.

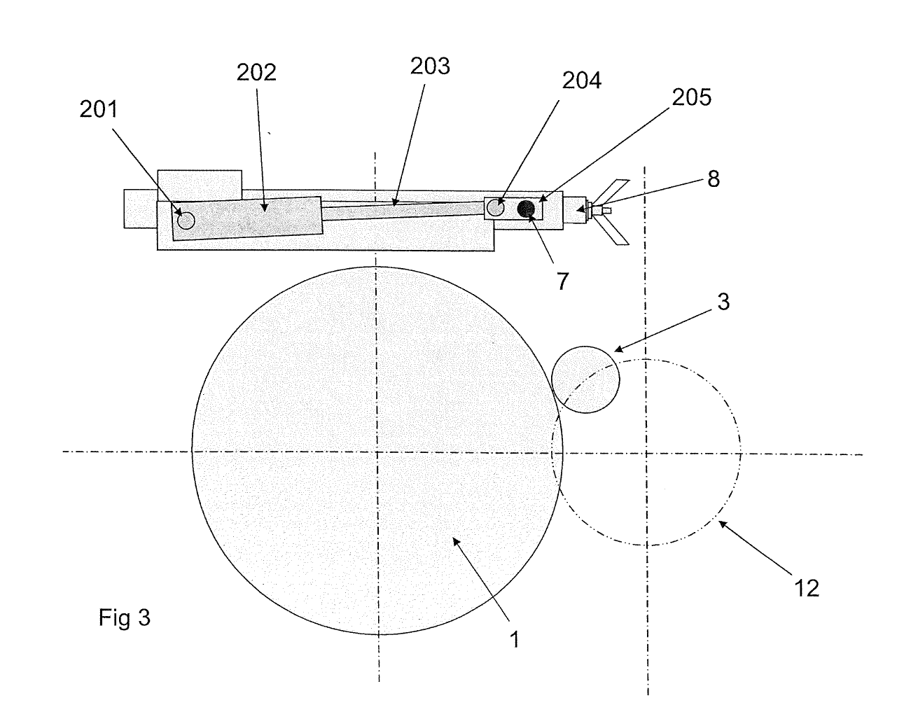

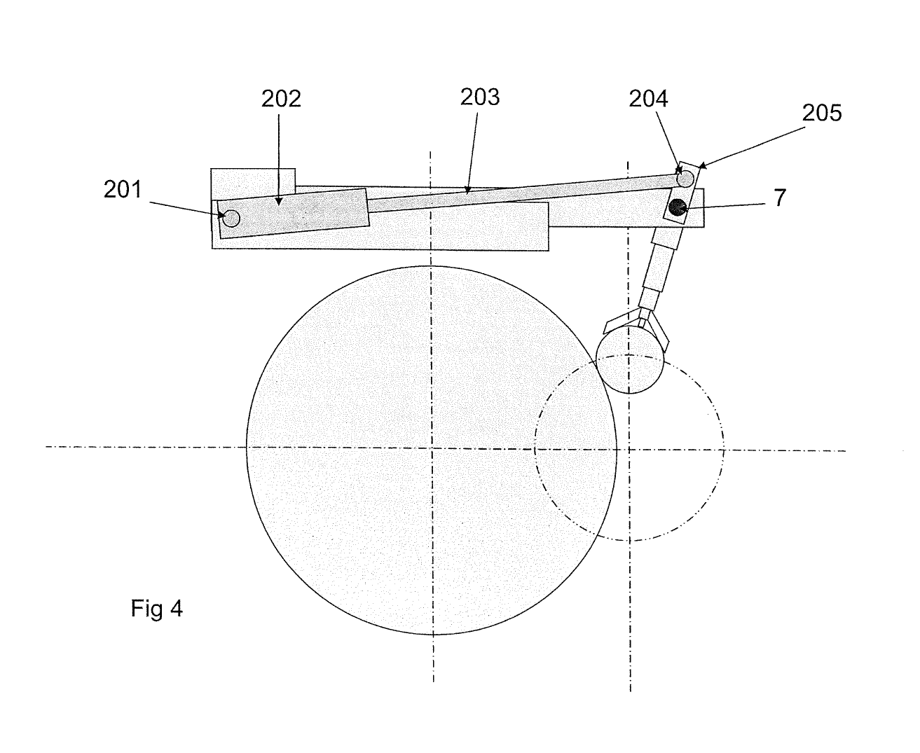

A retractor may be provided in the assembly of the present invention to move telescoping rod 8 and the gauge head 10 clear of the working region, for example to enable a workpiece to be loaded and/or other tooling to be set up on the machine. An implementation of such a retractor is depicted in FIGS. 3 and 4. The orientation of the retractor whilst the gauge head is in contact with the workpiece is shown in FIG. 4, whilst the gauge head is shown in its retracted position in FIG. 3.

A piston 202 is pivotally mounted on the slide support for rotation about pivot 201. The piston drives a piston arm 203, the distal end of which is pivotally coupled to a linkage 205 at pivot 204.

Actuation of the piston 202 to draw piston rod 203 towards it causes linkage 205 to rotate about pivot 7. This motion is transmitted to telescoping rod 8 via pivot 7 to cause telescoping rod 8 to rotate upwardly, anticlockwise in the view of FIGS. 3 and 4. The force exerted by the piston rod is sufficient to overcome the centralising mechanism provided to constrain rotation of the telescoping rod about pivot 7 whilst the gauge head is in contact with a workpiece.

A “park” or “clear” articulation point is reached when the telescoping rod 8 is parallel with the gauge slide 6.

Piston 202 may be in the form of a pneumatic or hydraulic cylinder. The cylinder may be selected according to the required speed of operation and the size of the assembly concerned.

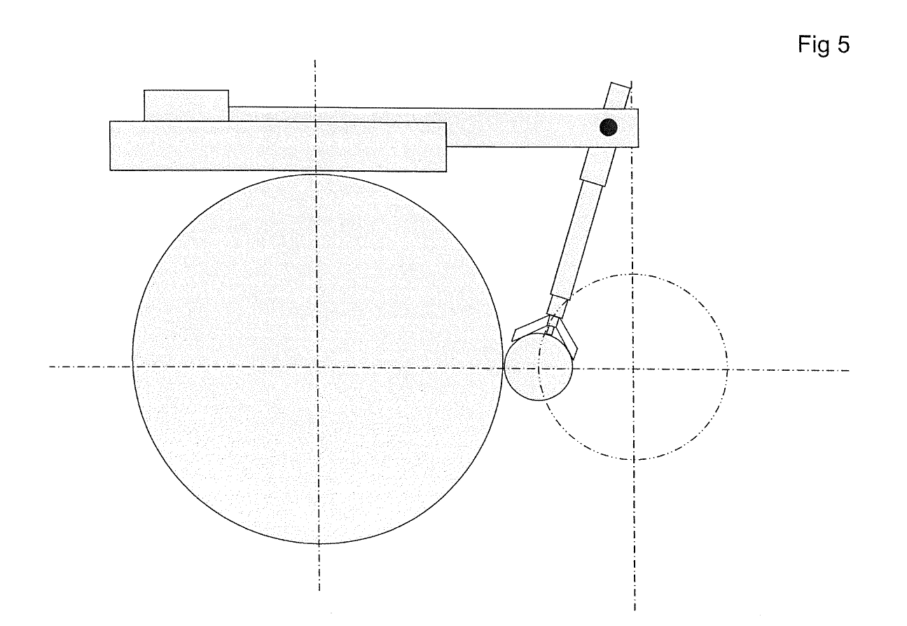

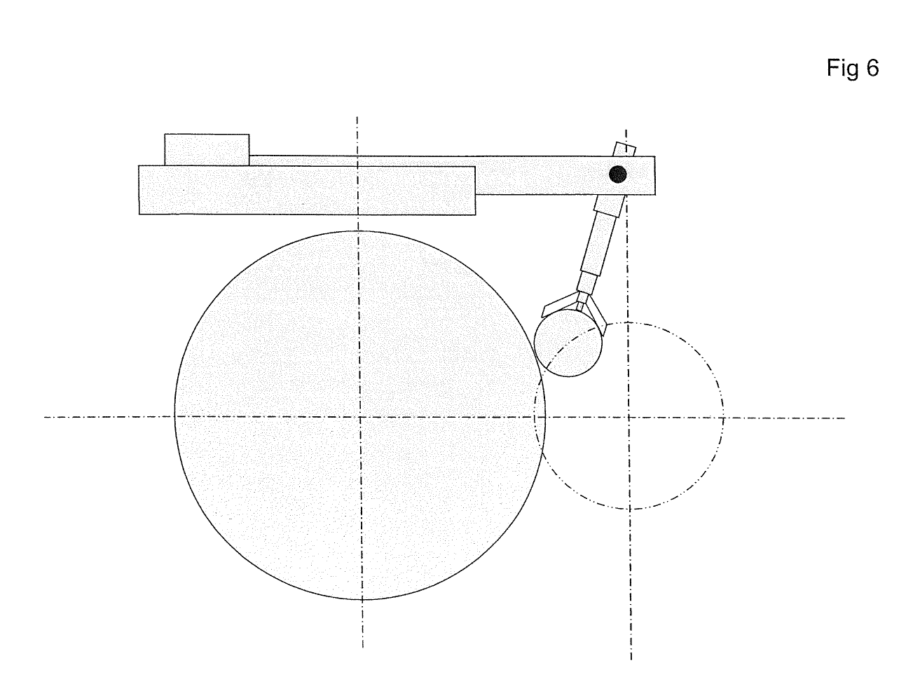

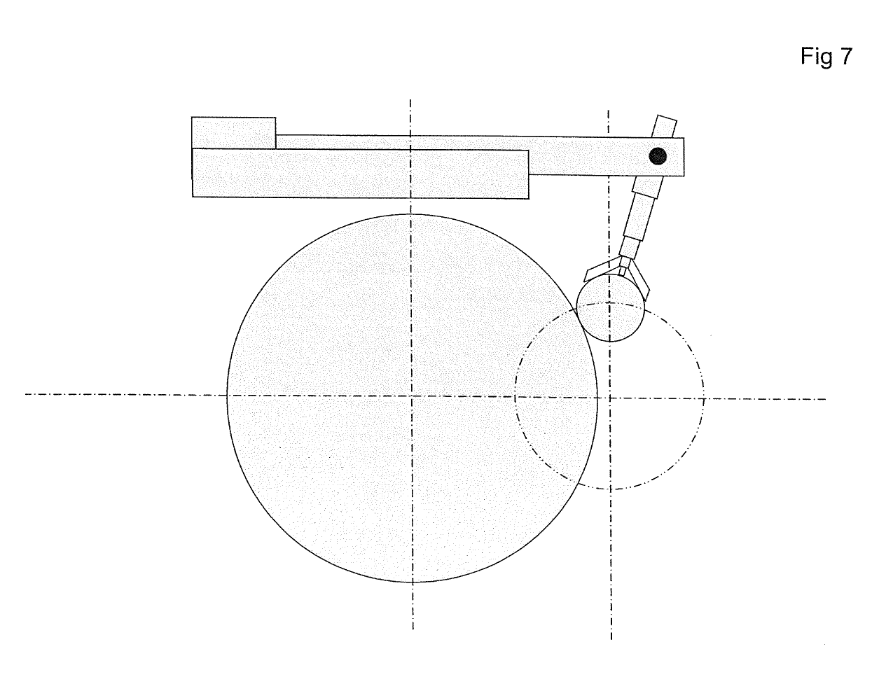

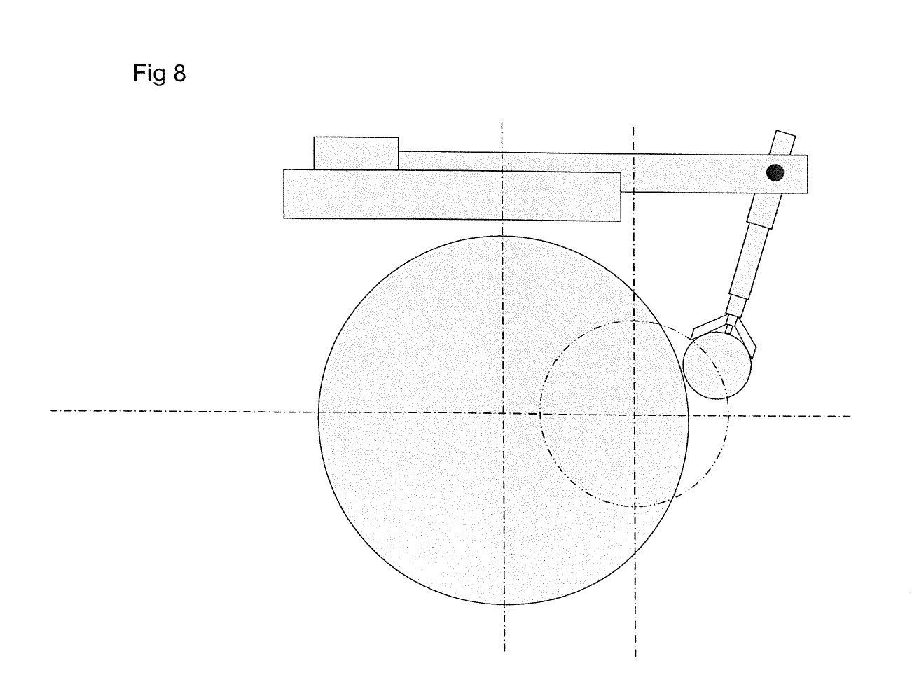

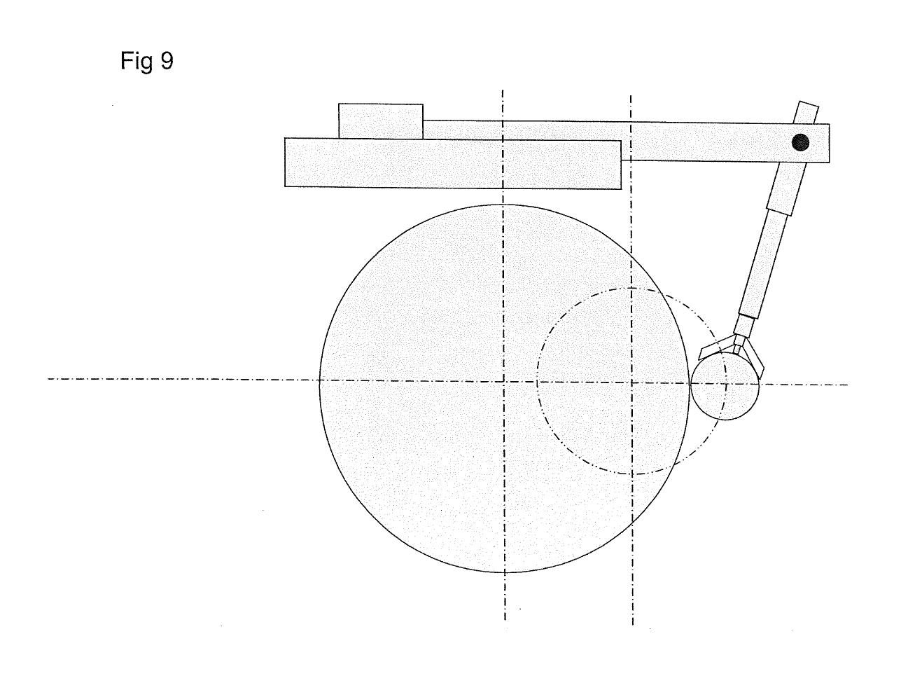

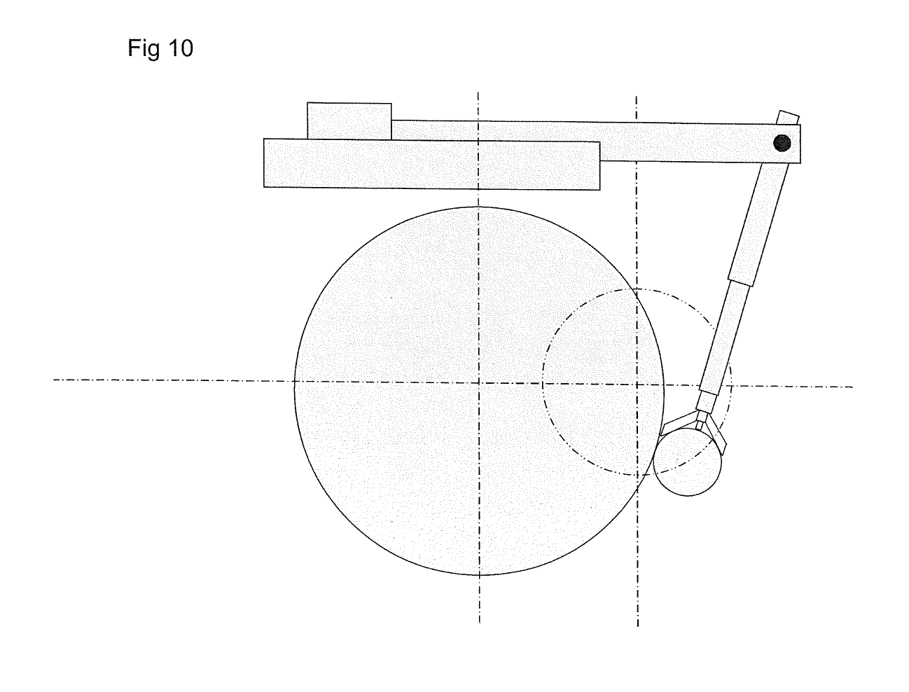

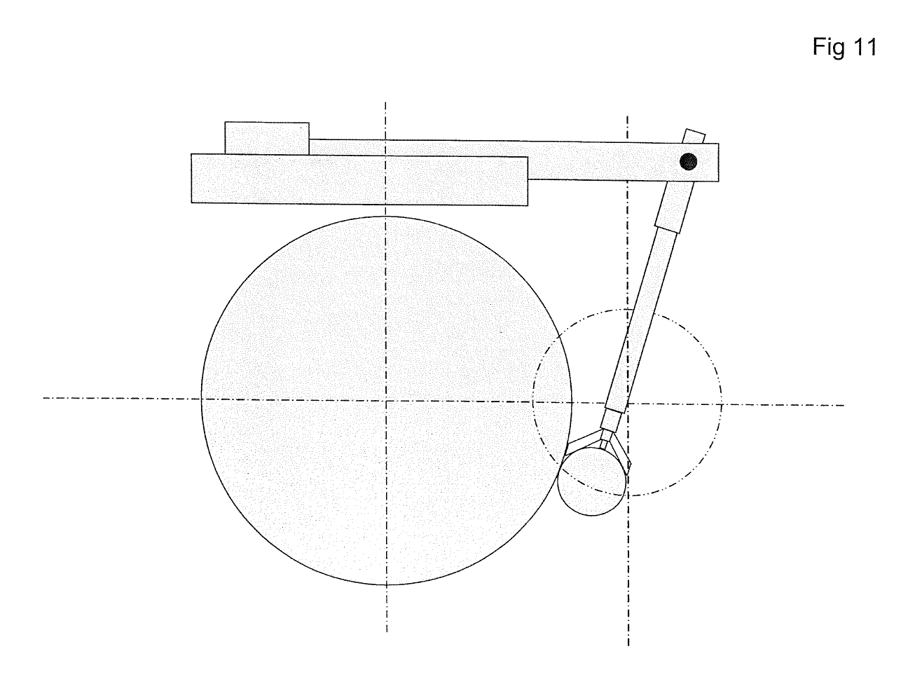

In order to illustrate operation of an assembly embodying the invention in practice to follow a workpiece along an orbital path, FIGS. 5 to 11 show a sequence of successive stages in the motion of the workpiece. It can be seen that the gauge head is maintained in intimate contact with the workpiece throughout its motion along the orbital path, without coming into contact with the grinding wheel.

Although a measuring gauge in the form of a vee or finger gauge is shown in the drawings, it will be appreciated that an assembly embodying the present invention may be used to support a range of measuring gauges such as an eddy current probe, a capacitance gauge, a Barkhausen noise detector, an ultrasound scanning head or indeed any transducer system that needs to follow the movement of the workpiece.

1. An assembly for carrying a measuring gauge to be maintained in contact with a portion of a workpiece mounted in a machine tool arranged to rotate the workpiece about a machine reference axis, the portion of the workpiece following an orbital path around said machine reference axis as the workpiece rotates, wherein the assembly is for mounting on a carriage shared with a material removing tool of said machine tool and comprises:
a slide support;
a slide which is mounted on the slide support so as to be slidable with respect to the slide support and the material removing tool along a linear axis, the linear axis being parallel in use to the direction of infeed of said material removing tool;
a mount for connection to said measuring gauge;
a mount coupling which couples the mount to the slide, is pivotally mounted on the slide by a pivot and is arranged to accommodate variation of the spacing between the mount and the pivot due to the orbital motion of said workpiece portion; and
a slide driver arranged to reciprocate the slide relative to the slide support in synchronism with the orbital motion of said workpiece portion.

2. (canceled)

3. (canceled)

4. (canceled)

5. (canceled)

6. (canceled)

7. An assembly of claim 1, wherein the mount coupling is arranged to accommodate variation of the spacing between the mount and the pivot along a linear reference axis.

8. An assembly of claim 7, wherein the mount coupling is telescopic.

9. (canceled)

10. An assembly of claim 1, wherein the mount coupling includes a preload device for biasing a measuring gauge mounted on the assembly in contact with a workpiece towards the workpiece.

11. An assembly of claim 10, wherein the preload device comprises at least one of a resilient mechanical mechanism, a pneumatic mechanism, and a hydraulic mechanism.

12. An assembly of claim 1, wherein the slide driver comprises a linear motor.

13. An assembly of claim 1, wherein the slide driver comprises a rotary motor.

14. An assembly of claim 1, including a retractor for retracting the mount away from the machine reference axis.

15. An assembly of claim 14, wherein the retractor is arranged to pivot the mount coupling upwards.

16. An assembly of claim 14, wherein the retractor comprises a piston, and a piston rod coupling the piston to the mount coupling such that actuation of the piston causes the linear reference axis of the mount coupling to pivot relative to the slide.

17. An assembly of claim 1 in combination with a controller for controlling the slide driver.

18. A machine tool including an assembly of claim 1.

19. A machine tool of claim 18, wherein the controller of the machine tool is arranged to control the slide driver.

20. A machine tool of claim 18, wherein the assembly is supported by a carriage which is also arranged to carry a material removing tool for engagement with a workpiece mounted on the machine tool.

21. A machine tool of claim 20, wherein the material removing tool is a grinding wheel.

22. A method for maintaining a measuring gauge in engagement with a portion of a workpiece following an orbital path in a machine tool about a machine reference axis as the workpiece is rotated by the machine tool, the machine tool including a material removing tool, and the method comprising the steps of:
providing an assembly carrying the measuring gauge, the assembly including a slide which is mounted on a slide support so as to be slidable with respect to the slide support and the material removing tool along a linear reference axis, a mount connected to the measuring gauge, and a mount coupling which couples the mount to the slide, is pivotally mounted on the slide by a pivot and is arranged to accommodate variation in the spacing between the mount and the pivot due to said orbital motion of the workpiece portion;
mounting the assembly on a carriage shared with the material removing tool of the machine tool, with the linear reference axis of the slide parallel to the direction of infeed of the material removing tool;
arranging the assembly such that the measuring gauge is in engagement with the portion of the workpiece;
rotating the workpiece about the machine reference axis; and
reciprocating the slide relative to the slide support substantially in synchronism with the orbital motion of said workpiece portion about the machine reference axis, with the assembly accommodating changes in the location of the measuring gauge relative to the slide support so as to maintain the measuring gauge in engagement with the portion of the workpiece.

23. (canceled)

24. (canceled)

25. (canceled)

26. (canceled)

27. (canceled)

28. A method of claim 22, wherein the workpiece is a crankshaft and the portion of the workpiece is a crank pin.

29. (canceled)

30. (canceled)

31. (canceled)
